(19) United States
(12) Patent Application Publication
(10) Pub. No.: US 2019/0075928 A1
(43) Pub. Date: Mar. 14, 2019

(54) CUP HOLDER

(71) Applicant: Chris Stigas, Toronto (CA)

(72) Inventor: Chris Stigas, Toronto (CA)

(21) Appl. No.: 15/701,790

(22) Filed: Sep. 12, 2017

(51) Int. Cl. A47C 7/68; A61G 5/10

(52) U.S. Cl. CPC A47C 7/68; A61G 5/10

(57) ABSTRACT

A cup holder comprises a body configured to receive a cup, and a generally planar support extending from the body, the generally planar support insertable between a seat and an underlying structure supporting the seat such that the cup holder is removably secured between the seat and the underlying structure supporting the seat by friction and at least one of a weight of the seat and a weight of a user sitting in the seat

### FIELD

The following relates generally to cup holders and more particularly to a cup holder removably securable to a seat.

### BACKGROUND

Cup holders are secured to seats in a variety of ways to provide a convenient and secure way of holding beverages and other loose objects. For example, U.S. Pat. No. 7,108,321 to Davis discloses a forward leaning stadium seat having a padded seat, a vertical support sleeve with an arm support device and quick release locking clasp to allow quick and easy up and down positioning of the arm support device and an adjustable hub to stop the forward and backward movement of the vertical support device at prescribed locations within a prescribed arc of travel.

U.S. Pat. No. 8,777,307 to Nelson et al. discloses a cup-holding device configured to be retrofitted to an seat arm or other horizontal support structure. The cup-holding device has a basket in a seat-mounting portion wherein there is sufficient rigidity of the structure to hold a cup or similar small item(s).

U.S. Pat. No. 6,896,231 to Sullivan, Sr. discloses a drink holder for disabled persons with the holder being adapted to be secured to a chair, wheelchair, bed, wall, etc. A cup holder is mounted to the outer end of an articulated arm assembly with the assembly being adjustable to properly position the cup holder. When a cup or glass is placed in the cup holder, a disabled person may move his or her head to gain access to the straw extending from the cup or glass in the cup holder.

U.S. Patent Application Publication No. 2009/0032657 to Huang discloses a drink cup holder mount that includes a drink cup holder unit having a fixing rod sideward extended from a peripheral wall thereof, a mounting unit having two through holes correspondingly formed thereon, a fastening element, and at least one packing pad for inserting in the mounting unit.

Although cup holders have been considered, improvements are desired. It is therefore an object at least to provide a novel cup holder.

### SUMMARY

Accordingly, in one aspect there is provided a cup holder comprising a body configured to receive a cup, and a generally planar support extending from the body, the generally planar support insertable between a seat and an underlying structure supporting the seat such that the cup holder is removably secured between the seat and the underlying structure supporting the seat by friction and at least one of a weight of the seat and a weight of a user sitting in the seat.

In an embodiment, the planar support has a minimal thickness such that the seat remains generally flat when the planar support is positioned between the seat and the underlying structure. The minimal thickness may be between 2.5 to 5 millimeters.

In an embodiment the planar support is tapered from a first end adjacent to the body to a second end opposite the first end.

In an embodiment, the planar support has a footprint that is smaller than that of the seat. The planar support may be rectangular.

In an embodiment, the body comprises a slot for providing access to a handle of the cup.

In an embodiment, a removable attachment is positionable within the body to increase a depth of the cup holder. The removable attachment may comprise at least one slot to provide access to a handle of the cup.

In an embodiment, a removable attachment is positionable within the body to decrease a depth of the cup holder.

In an embodiment, a bottom of the body comprises a number of openings configured to accommodate one or more objects in the cup holder underneath the cup while maintaining the cup in a generally flat position.

According to another aspect there is provided a cup holder removably securable to a wheelchair, the cup holder comprising a body configured to receive a cup and comprising at least one slot for providing access to a handle of the cup, and a generally planar support extending from and perpendicular to a longitudinal axis of the body, the generally planar support insertable between a seat of the wheelchair and an underlying structure of the wheelchair such that the cup holder is removably secured to the wheelchair by friction and at least one of a weight of the seat and a weight of a user sitting on the seat.

### BRIEF DESCRIPTION OF THE DRAWINGS

Embodiments are described herein with reference to the accompanying drawings, in which like reference characters refer to like elements and in which:

FIG. 1 is an axonometric view of an embodiment of a cup holder;

FIG. 2 is an exploded axonometric view of the cup holder of FIG. 1;

FIG. 3 is an exploded right side view of the cup holder of FIG. 1;

FIG. 4 is an exploded front view of the cup holder of FIG. 1;

FIG. 5 is a top view of the cup holder of FIG. 1;

FIG. 6 is a perspective view of the cup holder of FIG. 1, secured to a mobility device.

FIG. 7 is an exploded axonometric view of another embodiment of a cup holder;

FIG. 8 is an exploded right side view of the cup holder of FIG. 7;

FIG. 9 is an exploded front view of the cup holder of FIG. 7;

FIG. 10 is a top view of the cup holder of FIG. 7, without the removable attachment;

FIG. 11 is a top view of the removable attachment of the cup holder of FIG. 7; and

### DETAILED DESCRIPTION OF EMBODIMENTS

In the following, a cup holder is described. The cup holder comprises a body configured to receive a cup. A generally planar support extends from the body. The generally planar support is insertable between a seat and an underlying structure supporting the seat. As such, the cup holder is removably secured between the seat and the underlying structure supporting the seat by friction and at least one of a weight of the seat and a weight of a user sitting in the seat.

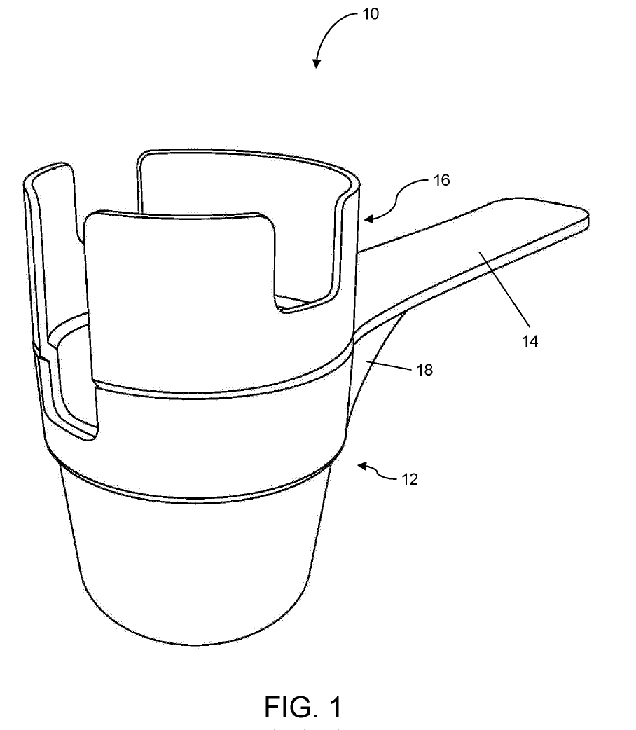

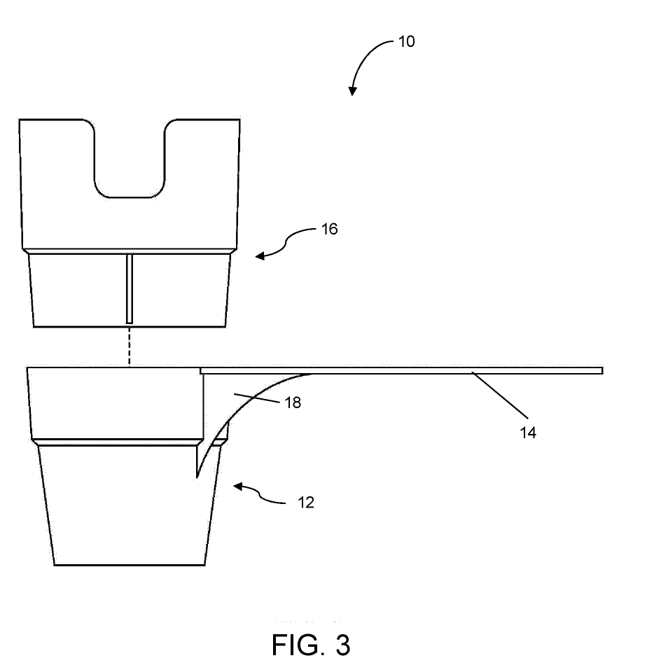

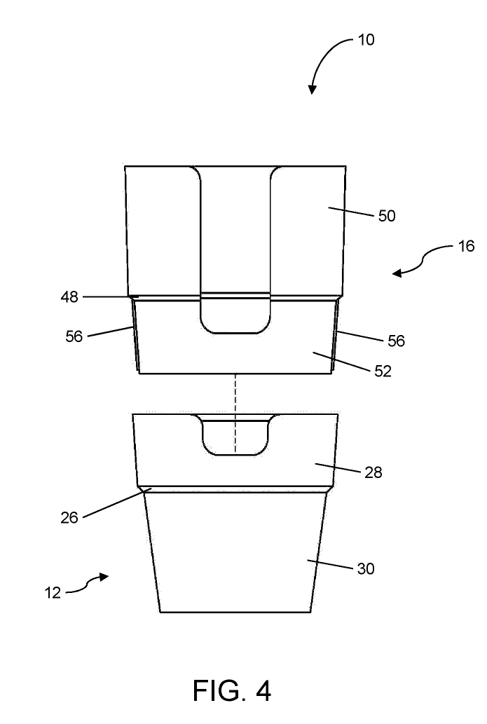

Turning now to FIGS. 1 to 5, an exemplary cup holder is shown and is generally identified by reference character 10. In this embodiment, the cup holder 10 includes a body 12 and a generally planar support 14. The generally planar support 14 extends horizontally from the body 12 at a direction generally perpendicular to a longitudinal axis of the body 12. A reinforcement 18 extends between the body 12 and the generally planar support 14. The body 12, generally planar support 14 and reinforcement 18 are of a unitary design. Put another way, the body 12, generally planar support 14 and reinforcement 18 are made of a single piece of rigid material such as for example plastic. A removable attachment 16 is connectable to the body 12 to increase the depth of the cup holder 10 as will be described in more detail below.

The body 12 is configured to receive a cup. Specifically, in this embodiment, the body 12 comprises a circular peripheral wall 20 and a base 22. The peripheral wall 20 defines a void 24 for receiving a cup (not shown) and tapers towards the base 22. The base 22 supports the cup when received in the void 24. As will be appreciated, the cup may additionally (or alternatively) be supported by the body 12 through contact with the peripheral wall 20, for example through an interference fit between the cup and the peripheral wall 20. The peripheral wall 20 defines a shoulder 26 approximately two-thirds of the way up the peripheral wall 20 from the base 22. The shoulder 26 delimits an upper portion 28 of the body 12 from a lower portion 30 of the body 12, by being located therebetween.

A slot 32 is defined in the upper portion 28 of the body 12. The slot 32 is used to provide access to a handle of the cup. Further, the slot 32 may be used to orient the cup in a predetermined position, when received by the cup holder 10. As will be appreciated, orienting the cup in a predetermined position can make it easier to remove the cup from the cup holder 10 via the handle of the cup, particularly for disabled persons with limited mobility. The upper portion 28 of the body 12 comprises mating portions in the form of a plurality of recesses 34 spaced about an inner surface 36 of the upper portion 28 of the body 12. The recesses 34 are arranged at predetermined positions about the inner surface 36 to help align the removable attachment 16 when connected to the body 12, as will be described in more detail below.

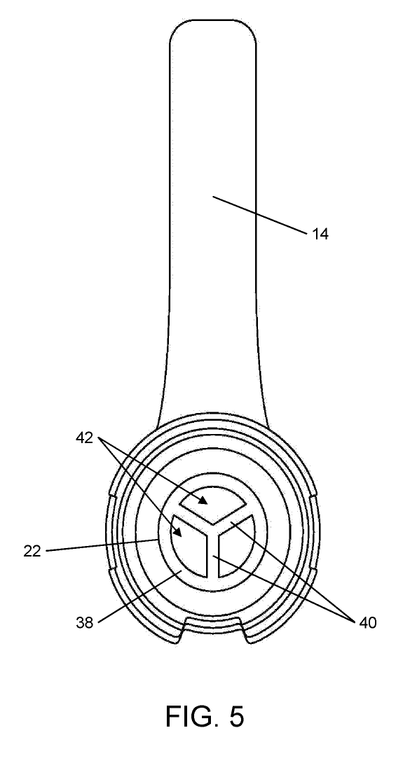

The lower portion 30 of the body 12 includes the base 22. As best shown in FIG. 5, the base 22 includes a circumferential ring 38 and a plurality of spokes 40 that extend from a center of the base 22 to the circumferential ring 38. The spokes 40 and the ring 38 define a plurality of holes 42 through the base 22. In use, objects such as for example keys can be accommodated in the lower portion 30 of the body 12 and retained by the base 22. The holes 42 in the base 22 permit the objects like keys to dangle below the bottom of the cup holder 10, to avoid interfering with a cup when placed in the cup holder 10.

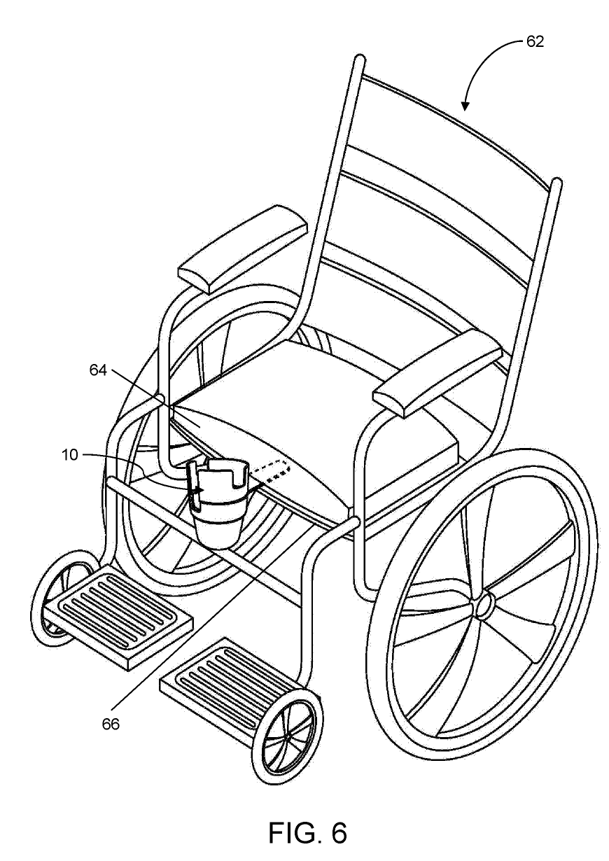

The generally planar support 14 extends from and is generally perpendicular to a longitudinal axis of the body 12. In this embodiment, the generally planar support 14 is generally rectangular and is made of a resilient material such as for example plastic, metal, carbon fiber, etc. The generally planar support 14 has a thickness of approximately 2.5 millimeters to 5 millimeters. The generally planar support 14 is configured to be wedged between a seat and an underlying structure supporting the seat to removably secure the cup holder between the seat and the underlying structure, as shown in FIG. 6 and described in more detail below.

The reinforcement 18 extends between the body 12 and the generally planar support 14 of the cup holder 10. In this embodiment, the reinforcement 18 is generally triangular when viewed from a side of the cup holder 10. The reinforcement 18 helps to reinforce and helps to stiffen the connection between the body 12 and the generally planar support 14, which can help to reduce deflection of the body 12 when supporting particularly heavy cups (such as full travel mugs).

As mentioned previously, the removable attachment 16 is connectable to the body 12 to increase the depth of the cup holder 10. In this embodiment, the removable attachment 16 has a circular peripheral wall 44 that defines a through passage 46 for receiving a cup. The peripheral wall 44 tapers from the top to the bottom of the removable attachment 16 and defines a continuous taper with that of the upper portion 28 of the body 12 when the removable attachment 16 is connected to the body 12. The peripheral wall 44 of the removable attachment 16 defines a shoulder 48 approximately one-third of the way up the peripheral wall 44. The shoulder 48 delimits an upper portion 50 of the removable attachment 16 from a lower portion 52 of the removable attachment 16, by being located therebetween.

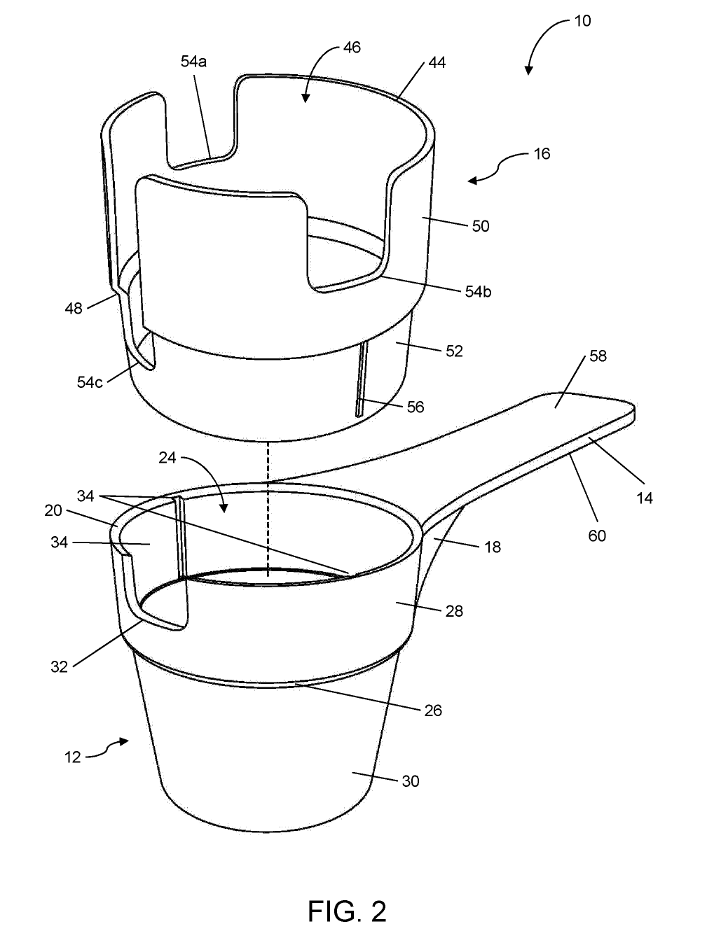

The upper portion 50 of the removable attachment 16 includes a plurality of slots 54a, 54b, 54c. In this embodiment, slots 54a and 54b have the same depth as one another and slot 54c has a different depth. Specifically, as shown in FIG. 2, the two slots 54a, 54b on the sides of the upper portion 50 have the same depth as one another and the third slot 54c on the front of the upper portion 50 has a greater depth than that of slots 54a and 54b and extends into the lower portion 52 of the removable attachment 16. When the removable attachment 16 is connected to the body 12, the slot 54c in the removable attachment 16 can be aligned with the slot 32 in the body 12.

The lower portion 52 of the removable attachment 16 includes a plurality of mating portions in the form of tabs 56 spaced about an outer surface of the lower portion 52 of the removable attachment 16. The tabs 56 are sized and spaced to mate with the recesses 34 in the upper portion 28 of the body 12. The lower portion 52 also includes a portion of the slot 54c, as described above.

When the removable attachment 16 is connected to the body 12, the lower portion 52 of the removable attachment 16 mates with the upper portion 28 of the body 12 and secures the removable attachment 16 to the body 12. In this arrangement, the through passage 46 of the removable attachment 16 aligns with the void 24 of the body 12 to increase a depth within the cup holder 10. This allows the cup holder 10 to provide stability for taller cups (when the removable attachment 16 is connected to the body 12), while still accommodating shorter cups (when the removable attachment 16 is not connected to the body 12).

Additionally, when the body 12 and the removable attachment 16 are connected, the tabs 56 and the recesses 34 interconnect to align the removable attachment 16 in a predetermined position with respect to the body 12. This can help to align the slot 54c in the removable attachment 16 with the slot 32 in the body 12.

During use, the cup holder 10 is positioned between a seat and underlying structure beneath the seat. An example is shown in FIG. 6 wherein the cup holder 10 is removably secured to a wheelchair 62. As can be seen, the generally planar support 14 (shown in dashed lines) is positioned between a seat 64 of the wheel chair 62 and underlying structure 66 supporting the seat 64. The cup holder 10 is held in place by the weight of the seat 64 and the weight of a user, once the user has sat in the seat 64. In this embodiment, the generally planar support 14 is positioned beneath the seat 64 at an approximate midpoint thereof, such that the cup holder 10 accessible in between the users legs when the user is sitting on the seat 64. As will be appreciated, this helps to keep the cup holder 10 within the original footprint of the wheelchair 62 such that the cup holder 10 is less likely to impact nearby objects and less likely to interfere with the maneuverability of the wheelchair 62. In contrast, existing cup holders swing or extend beyond the original length and/or width of the mobility device and can inconveniently catch, snag or bump into nearby objects, such as people and obstructions like doorways, walls, corners, fences, bushes, etc. As described above, because the generally planar support 14 is generally planar and relatively thin, the support 14 maintains the seat 64 in a generally flat position. Put another way, the support 14 does not substantially deform or reposition (i.e. raise, tilt or slant) the seat 64 when positioned underneath. The cup holder 10 may be removed from the wheelchair 62 while the user is sitting therein as desired. As such, the cup holder 10 may be removed as desired, when the user no longer requires the cup holder 10 or when the user is getting out of the wheelchair 62.

Once the cup holder 10 is secured to the wheelchair 62 and the user is sitting on the seat 64, a cup (not shown) such as for example a disposable coffee cup, a reusable coffee mug, a water bottle, an aluminum can, etc. may be placed in the cup holder 10. The weight of the seat 64 and the weight of the user sitting in the seat 64 helps to keep the cup holder 10 in place thereby preventing the cup from tipping over. In the event the cup has a handle, the cup may be positioned such that the handle of the cup is adjacent to one of the slots of the body 12 and, the removable attachment 16, if the removable attachment 16 is connected to the body 12. As such, the handle of the cup is readily accessible thereby allowing the user to easily remove the cup from the cup holder 10 by picking or scooping up the handle of the cup.

As will be appreciated, the cup holder 10 permits a user with limited mobility to easily pick up and replace a cup. The cup holder 10 is removably secured to the wheelchair at a position to ensure the footprint of the wheelchair is not changed to reduce the risk of the cup holder bumping into objects such as door frames, etc. Further, the cup holder 10 can be easily removed from the wheel chair when it is no longer needed.

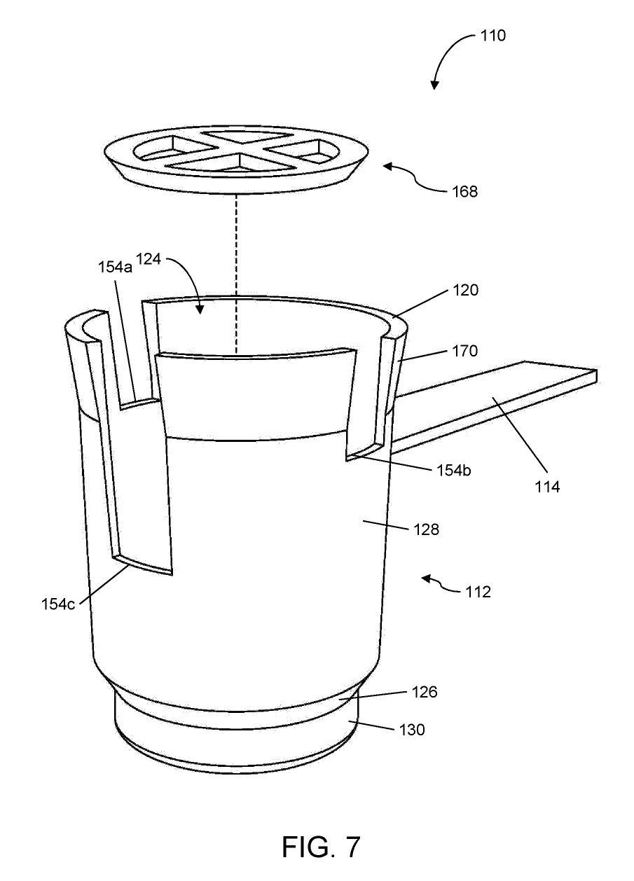

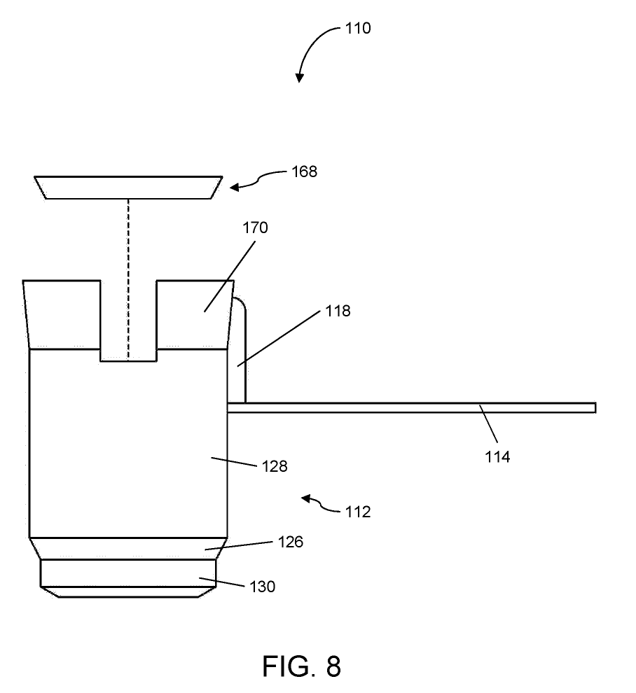

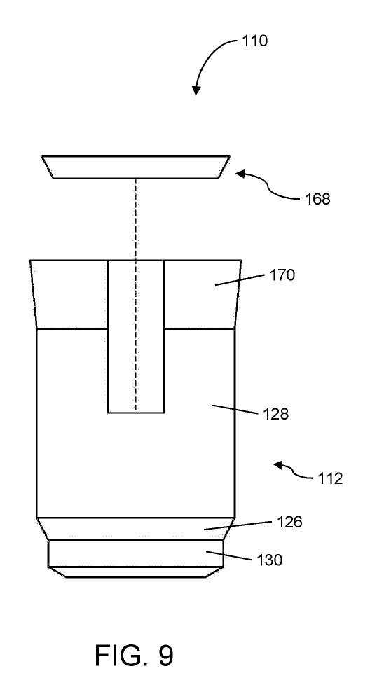

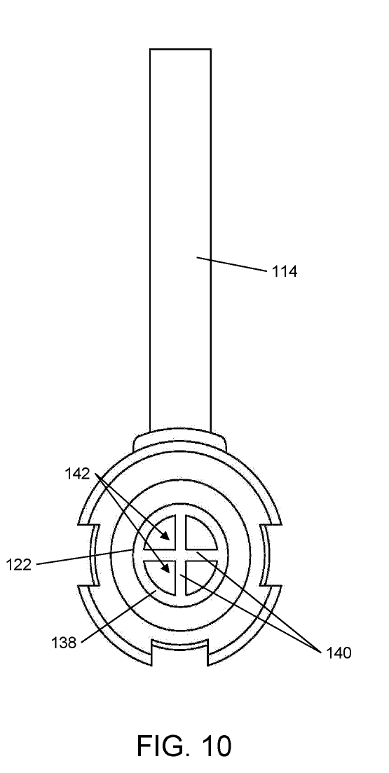

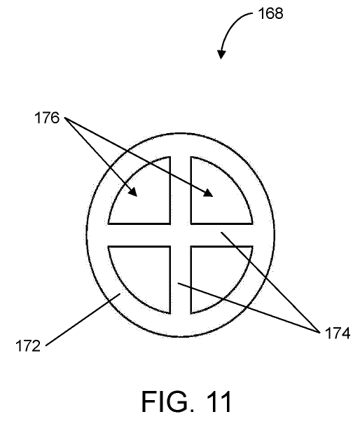

Turning now to FIGS. 7 to 11, another embodiment of a cup holder is shown and is generally identified by reference character 110. The cup holder 110 is similar to the cup holder 10 and as such elements of cup holder 110 that are generally similar to those of cup holder 10 are identified with similar reference characters, incremented by 100 for clarity.

The cup holder 110 is similar to cup holder 10 with the following exceptions. In this embodiment, rather than having a removable attachment 16, the cup holder 110 comprises a removable attachment 168. The removable attachment 168 is insertable into the body 112 of the cup holder 110 to decrease a depth within the cup holder 110.

In this embodiment, the removable attachment 168 comprises a circumferential ring 172 and a plurality of spokes 174 that extend from a center of the removable attachment 168 to the circumferential ring 172. The spokes 174 and ring 172 define a plurality of holes 176 through the removable attachment 168. The maximum outer diameter of the removable attachment 168 is larger than the maximum inner diameter of the lower portion 130 of the peripheral wall 120, but is smaller than the maximum inner diameter of the upper portion 128. Accordingly, when the removable attachment 168 is inserted into the void 124 of the body 112, the removable attachment 168 rests on the inner surface of the peripheral wall 120 at the shoulder 126 and is supported by the shoulder 126 above the base 122.

During use, the cup holder 110 is positioned between a seat and underlying structure beneath the seat as described above with reference to cup holder 10. However, in this embodiment, the removable attachment 168 may be inserted into the cup holder 110 to reduce the depth of the cup holder 11 to accommodate shorter cups.

As will be appreciated, the cup holder may be used to hold any type of cup such as for example disposable coffee cups, aluminum cans, coffee mugs, bottles, juice boxes, water bottles, etc.

Although in embodiments above the generally planar support is described as being generally rectangular and having a thickness of approximately 2.5 mm to 5 mm, those skilled in the art will appreciate that alternatives are available. For example, in another embodiment the generally planar support is tapered such that a thickness of the generally planar support gradually decreases as it extends from the body. In this embodiment, the thickness of the generally planar support may be approximately 5mm at a first end thereof adjacent to the body and may gradually reduce to 0.5 mm at a second end thereof opposite the first end.

As will be appreciated, the cup holder may be made of any type of rigid material such as for example plastic or metal. The cup holder may be manufactured by three-dimensional printing. The body and the generally planar support may be of a unitary design to expedite the time of manufacturing while also reducing the cost. The body and the generally planar support may alternatively be two separate components attached to one another via a fastening device such as for example a screw or mating formations or other suitable means such as for example glue, etc.

Although in embodiments described above the base of the cup holder is described as comprising holes, those skilled in the art will appreciate that alternatives are available. For example, in another embodiment the base may be a continuous plate without any holes.

Although in embodiments described above the body of the cup holder and the removable attachment are described as comprising mating portions in the form of tabs and slots, those skilled in the art will appreciate that other mating portions may be used. Further, in other embodiments additional mating portions may be used to permit the removable attachment to be positioned in one of a plurality of desired orientations or positions such that different combinations of slots may be aligned to accommodate different sizes and types of cups and

Although in embodiments described above the generally planar support is described as being generally flat, those skilled in the art will appreciate that in other embodiments top and/or bottom surfaces of the generally planar support may be textured to increase friction between the generally planar support and the seat and structure underneath the seat. For example, small teeth or bumps may extend from the top surface, the bottom surface or both the top and bottom surface of the generally planar support.

Although embodiments have been described, it will be appreciated by those skilled in the art that variations and modifications may be made without departing from the scope defined by the appended claims, and the scope of the claims should be given the broadest interpretation consistent with the description as a whole.

1. A cup holder comprising:
a body configured to receive a cup, the body comprising a base configured to support a weight of the cup and a peripheral wall extending from the base;
a generally planar support extending from the peripheral wall at a location above the base, the generally planar support, when inserted between a seat and an underlying structure supporting the seat, removably securing the cup holder between the seat and the underlying structure supporting the seat by friction and at least one of a weight of the seat and a weight of a user sitting in the seat; and
a removable attachment insertable into the body to decrease a depth of the cup holder, the removable attachment, when inserted into the body, being supported above the base by an inner surface of the peripheral wall,
wherein at least one of the base and the removable attachment comprise a circumferential ring and a plurality of spokes that extend inward from the circumferential ring to define a number of openings, and
wherein the cup holder is configured to accommodate one or more objects in the cup holder underneath the cup while maintaining the cup in a generally flat position.

2. The cup holder of claim 1 wherein the planar support has a minimal thickness such that the seat remains generally flat when the planar support is positioned between the seat and the underlying structure.

3. The cup holder of claim 1 wherein the planar support is tapered from a first end adjacent to the body to a second end opposite the first end.

4. The cup holder of claim 1 wherein the planar support is generally rectangular.

5. The cup holder of claim 1 wherein the planar support has at least one of a flat top surface and a flat bottom surface.

6. The cup holder of claim 1 wherein the planar support has at least one textured surface.

7. The cup holder of claim 2 wherein the minimal thickness is between about 2.5 to about 5 millimeters.

8. The cup holder of claim 1 further comprising a reinforcement extending between the generally planar support and the body.

9. The cup holder of claim 1 wherein the body comprises a slot for providing access to a handle of the cup.

10. The cup holder of claim 1 further comprising a second removable attachment connectable to the body to increase the depth of the cup holder.

11. The cup holder of claim 10 wherein the second removable attachment comprises at least one slot for providing access to a handle of the cup.

12. The cup holder of claim 11 wherein the at least one slot is a plurality of slots, at least two of the slots having different depths.

13. The cup holder of claim 10 wherein the body and the second removable attachment comprise complementary mating portions for connecting the body and the removable attachment in a particular position.

14. (canceled)

15. (canceled)

16. The cup holder of claim 1 wherein the cup holder is of a unitary design and is made of a plastic material.

17. A wheelchair comprising:
a seat;
an underlying structure supporting the seat;
a plurality of wheels rotatably connected to and supporting the underlying structure; and
a cup holder comprising:
a body configured to receive a cup, the body comprising a base configured to support a weight of the cup and a peripheral wall extending from the base; and
a generally planar support extending from and perpendicular to a longitudinal axis of the peripheral wall at a location above the base, the generally planar support being inserted between the seat of the wheelchair and the underlying structure of the wheelchair at approximately a midpoint of the seat such that the cup holder is removably secured to the wheelchair by friction and at least one of a weight of the seat and a weight of a user sitting on the seat and such that the cup holder is accessible between the legs of the user when sitting on the seat.

18. The cup holder of claim 17 wherein a bottom of the body comprises a number of openings configured to accommodate one or more objects in the cup holder underneath the cup while maintaining the cup in a generally flat position.

19. The cup holder of claim 17 wherein the cup holder is of a unitary design and is made of a plastic material.

20. The cup holder of claim 18 wherein the bottom of the body comprises a circumferential ring and a plurality of spokes that define the number of openings, and wherein the openings are shaped to permit at least one of the objects to dangle below the bottom of the body while being supported by at least one of the spokes.

21. The cup holder of claim 1 wherein the openings are shaped to permit at least one of the objects to dangle below the bottom of the body while being supported by at least one of the spokes.
